(19) United States
(12) Patent Application Publication
(10) Pub. No.: US 2020/0191822 A1
(43) Pub. Date: Jun. 18, 2020

(54) Rotary windproof satellite pot

(71) Applicant: Yaxin Shang, Guangzhou City (CN)

(72) Inventor: Yaxin Shang, Guangzhou City (CN)

(21) Appl. No.: 16/801,127

(22) Filed: Feb. 25, 2020

(30) Foreign Application Priority Data
Nov. 8, 2019 (CN) 2019110897035

(51) Int. Cl. G01P 13/00

(52) U.S. Cl. CPC G01P 13/0013; H01Q 1/24

(57) ABSTRACT

The invention discloses a rotatable windproof satellite pot, which includes a support base, a working cavity is arranged in the support base, a load-bearing block is provided on the upper side of the support base, and a satellite pot is provided on the upper side of the load-bearing block An intermittent motion mechanism is arranged in the working chamber, a lower end wall of the intermittent motion mechanism is rotatably provided with a transmission shaft whose upper end penetrates the upper end wall of the working chamber, and a hexagonal groove wheel is fixed on the transmission shaft in the working chamber. The device can automatically detect the wind direction.

### CROSS-REFERENCES TO RELATED APPLICATIONS

The present application claims priority from Chinese application No. 2019110897035 filed on Nov. 8, 2019 which is hereby incorporated by reference in its entirety.

### TECHNICAL FIELD

The present invention relates to field of satellite equipment, in particular to a rotary windproof satellite pot.

### BACKGROUND OF THE INVENTION

The shape of the satellite pan is a metal parabola, which is responsible for reflecting the satellite signals into the feed and tweeter located at the focal point of the satellite antenna. The role is to collect the weak signals from the satellite and remove the noise as much as possible, usually in remote areas. It is used for signal reception of TV programs, and the existing satellite pans are not standardized during installation, and are easy to fall off when exposed to strong winds, causing accidents, or affecting the ability to receive satellite signals, affecting program clarity.

### BRIEF SUMMARY OF THE INVENTION

The technical problem to be solved by the present invention is to provide a rotatable windproof satellite pot, which overcomes the problems that the satellite pot is easily affected by strong winds.

The present invention is achieved by the following technical solutions.

A rotatable windproof satellite cooker according to the present invention includes a support base, wherein the support base is provided with a working cavity, a load-bearing block is provided on the upper side of the support base, and a satellite pot is provided on the upper side of the load-bearing block. An intermittent motion mechanism is provided in the working chamber. A lower end wall of the intermittent motion mechanism is rotatably provided with a transmission shaft whose upper end penetrates the upper end wall of the working chamber. A hexagonal groove wheel is fixed on the transmission shaft in the working chamber. The right side of the hexagonal sheave is provided with a locking arc that cooperates with the hexagonal sheave, and the lower side of the locking arc is provided with a cylindrical pin. The locking arc can block the hexagonal sheave from actively rotating. With the cooperation of the locking arc and the hexagonal grooved wheel, rotating the cylindrical pin 180 degrees can drive the hexagonal grooved wheel to rotate 60 degrees, and the satellite pot can rotate 60 degrees with the hexagonal grooved wheel;

The load-bearing block is provided with a wind detection mechanism. The wind-detection mechanism includes a pressure sensor embedded in the load-bearing block. The pressure sensor is symmetrically provided with pressing blocks on the left and right sides, and the load-bearing block is symmetrical on the left and right sides. A wind deflector is provided, and the wind deflector moves toward the pressure sensor under the action of wind. The pressing block moves with the wind deflector. When the pressing block gives the pressure sensor pressure, The pressure sensor can drive the cylindrical pin to rotate;

An adjustment mechanism is provided on the upper side of the wind detection mechanism, and the adjustment mechanism is used to repeatedly adjust the angle of the satellite pot in a small range.

Preferably, the intermittent motion mechanism further includes a power motor fixedly connected to the lower end wall of the working chamber, the power motor is located on the right side of the transmission shaft, and a drive shaft is provided on the upper end surface of the power motor to rotate, and the drive A bottom rod and the locking arc are fixed on the shaft, and the cylindrical pin is fixed on the right side of the upper end surface of the bottom rod.

Preferably, the wind detection mechanism further includes two storage chambers symmetrically disposed in the load-bearing block, the storage chamber openings are far away from the pressure sensor, and the upper and lower end walls of the storage chambers are symmetrically provided with openings toward the housing. A moving groove of the storage cavity, a moving spring fixed on an end wall of the moving groove far from the pressure sensor, and one end of the moving spring near the pressure sensor is fixed with a moving block slidingly connected to the moving groove. A support rod that penetrates the storage cavity at one end remote from the pressure sensor is fixedly provided between the moving blocks, the pressing block and the support rod are fixedly connected to the end surface of the pressure sensor, and the windshield is connected with An end surface of the support rod away from the pressure sensor is fixedly connected, and an upper end wall of the moving groove on the upper side is provided with a top cavity communicating with the external space.

Preferably, the adjustment mechanism further comprises an adjustment motor fixedly connected to the right side of the upper end surface of the load-bearing block, a left end surface of the adjustment motor is rotatably provided with a power shaft, and a left end of the power shaft is fixed with a fan-shaped bevel gear. An extension rod is symmetrically fixed on the upper end surface of the load-bearing block. A positioning rod is fixed on the front end surface of the extension rod. A rotary rod is provided on the positioning rod through a torsion spring. The upper end of the transmission shaft is fixedly connected to the pressure sensor. A top rod fixedly connected to the load-bearing block is fixed on the upper end surface of the pressure sensor, and a pressure cavity with an upward opening is arranged in the upper end surface of the top rod, and an upper end is provided on the lower end wall of the pressure cavity through a pressure spring. A connecting shaft penetrating the upper end wall of the pressure chamber, the upper end of the connecting shaft is fixedly connected to the satellite pan, and a right-side moving groove is provided in the right end surface of the connecting shaft in the external space, and the upper end wall of the moving groove is fixed A movement spring is provided, and a movement rod slidingly connected to the movement groove is fixed at the lower end of the movement spring, and the right end of the movement rod penetrates the right end wall of the movement groove and is fixed. A transmission bevel gear, the drive bevel gear at the end faces symmetrical about a fixed connecting rod is provided, the two connecting rods fixed to the lower end is provided with an annular block.

Preferably, the sector bevel gear can mesh with the transmission bevel gear after the rotation.

Preferably, four weight blocks are evenly connected to the support base, and the weight blocks are used to stabilize the support base.

The beneficial effect of the present invention is that the device can automatically detect the wind direction. When the wind is strong, the satellite pot can be automatically rotated to the side to face the wind. The smaller satellite pot is exposed to wind to prevent damage. After turning, the satellite pot can be oriented Perform fine adjustment and adjust the satellite pot to accept the signal, so that the satellite pot is in a better working state. When the wind is strong, the function of fine tuning the satellite pot cannot be implemented to prevent damage to the satellite pot caused by misoperation.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those of ordinary skill in the art, other drawings can be obtained based on these drawings without paying creative labor.

FIG. 1 is a schematic front view of a rotatable windproof satellite cooker according to the present invention;

FIG. 2 is an enlarged schematic view of A in FIG. 1;

FIG. 3 is a schematic diagram in the direction of B-B in FIG. 1.

### DETAILED DESCRIPTION OF THE INVENTION

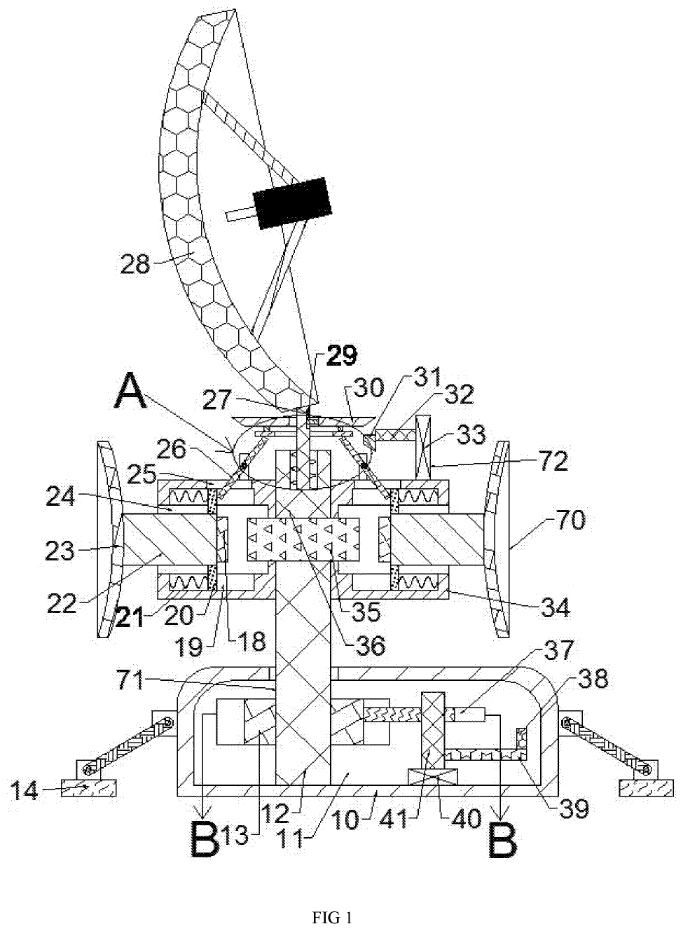

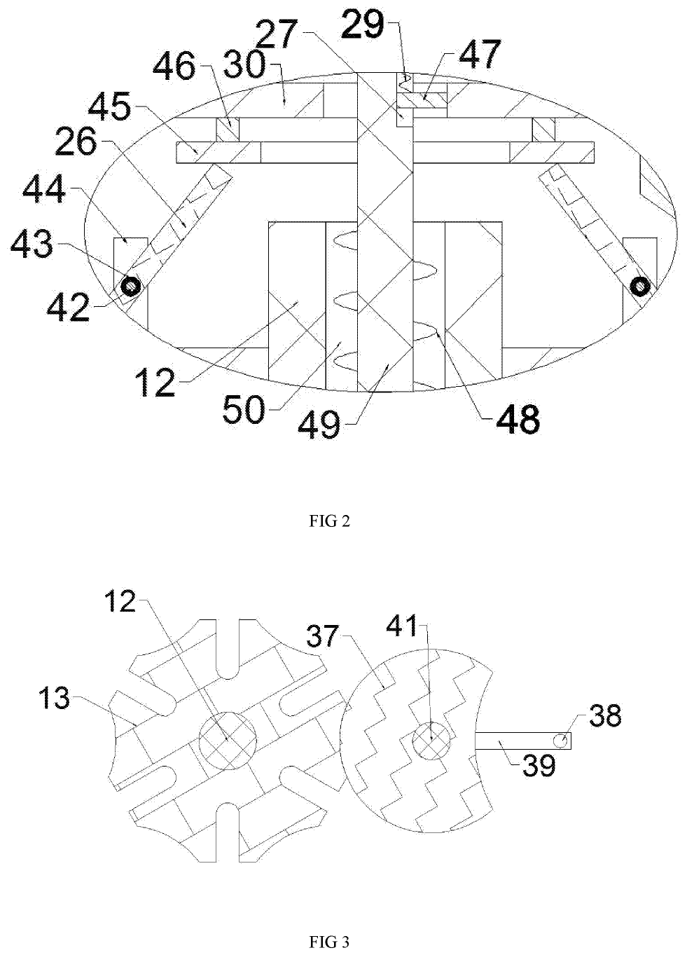

The present invention will be described in detail below with reference to FIGS. 1-3. Among them, for convenience of description, the orientation described below is defined as follows: the up-down, left-right, front-back direction described below is consistent with the up-down, left-right, front-back direction of the projection relationship of FIG. 1 itself.

Schematic diagram of the mechanical mechanism of a rotatable windproof satellite pan described in conjunction with FIGS. 1-3, including a support base 10, a working cavity 11 is provided in the support base 10, and a load-bearing block is provided on the upper side of the support base 10 34. A satellite pan 28 is provided on the upper side of the load-bearing block 34, and an intermittent motion mechanism 71 is provided in the working chamber 11. The lower end wall of the intermittent motion mechanism 71 is provided with a transmission through which an upper end penetrates the upper end wall of the working chamber 11. A shaft 12, a hexagonal sheave 13 is fixed on the transmission shaft 12 in the working cavity 11, and a locking arc 37 is provided on the right side of the hexagonal sheave 13 to cooperate with the hexagonal sheave 13, A cylindrical pin 38 is provided on the lower side of the locking arc 37, and the locking arc 37 can prevent the hexagonal sheave 13 from actively rotating. Through the cooperation of the locking arc 37 and the hexagonal sheave 13, the cylindrical pin 38 rotating 180 degrees can drive the hexagonal groove wheel 13 to rotate 60 degrees, and the satellite pot 28 can rotate 60 degrees with the hexagonal groove wheel 13;

The load-bearing block 34 is provided with a wind detection mechanism 70. The wind-detection mechanism 70 includes a pressure sensor 35 embedded in the load-bearing block 34. The pressure sensors 35 are provided with pressing blocks 18 symmetrically on the left and right sides. The load bearing block 34 is provided with windshields 23 symmetrically on the left and right sides, and the windshield 23 is moved toward the pressure sensor 35 under the action of the wind. The pressing block 18 moves with the windshield 23. When the pressing block 18 applies pressure to the pressure sensor 35, the pressure sensor 35 can drive the cylindrical pin 38 to rotate;

An adjustment mechanism 72 is provided on the upper side of the wind detection mechanism 70, and the adjustment mechanism 72 is used to repeatedly adjust the angle of the satellite pot 28 in a small range.

Beneficially, the intermittent motion mechanism 71 further includes a power motor 40 fixedly connected to the lower end wall of the working chamber 11. The power motor 40 is located on the right side of the transmission shaft 12. The driving shaft 41 is fixedly provided with a bottom rod 39 and the locking arc 37, and the cylindrical pin 38 is fixed on the right side of the upper end surface of the bottom rod 39.

Beneficially, the wind detection mechanism 70 further includes two storage cavities 24 symmetrically disposed in the load-bearing block 34 left and right, the storage cavity 24 opening away from the pressure sensor 35, and the upper and lower end walls of the storage cavity 24 being symmetrical A moving groove 19 having an opening toward the storage cavity 24 is provided. An end wall of the moving groove 19 away from the pressure sensor 35 is fixed with a moving spring 21. The moving spring 21 is fixed near one end of the pressure sensor 35. There is a moving block 20 slidably connected to the moving groove 19. A support rod 22 penetrating the receiving cavity 24 is fixed at one end away from the pressure sensor 35 between the two moving blocks 20, and the pressing block 18 and The end surface of the support rod 22 near the pressure sensor 35 is fixedly connected, the windshield plate 23 and the end surface of the support rod 22 away from the pressure sensor 35 are fixedly connected, and the upper end wall of the moving groove 19 on the upper side is provided with Top cavity 25 communicating with the outer space.

Advantageously, the adjustment mechanism 72 further includes an adjustment motor 33 fixedly connected to the right side of the upper end surface of the load bearing block 34. A left end surface of the adjustment motor 33 is rotatably provided with a power shaft 32, and a left end of the power shaft 32 is fixedly provided. The fan-shaped bevel gear 31 is provided with an extension rod 44 symmetrically fixed on the upper end surface of the load-bearing block 34. A positioning rod 42 is fixed on the front end surface of the extension rod 44. A rotation rod is provided on the positioning rod 42 through a torsion spring 43. 26. The upper end of the transmission shaft 12 is fixedly connected to the pressure sensor 35. The top end of the pressure sensor 35 is fixedly provided with a top rod 36 fixedly connected to the load bearing block 34. A pressure chamber 50 having an upward opening, and a lower end wall of the pressure chamber 50 is rotated by a pressure spring 48 to be provided with a connection shaft 49 having an upper end penetrating the upper end wall of the pressure chamber 50, and an upper end of the connection shaft 49 is fixedly connected to the satellite pot 28 In the outer space, a right-side moving groove 27 is provided in the right end face of the connecting shaft 49. A movement spring 29 is fixed on the upper end wall of the movement groove 27. A lower end of the movement spring 29 is fixedly connected with the movement groove. 27 sliding connection movement 47. The right end of the movement rod 47 penetrates the right end wall of the movement groove 27 and is fixedly provided with a transmission bevel gear 30. The lower end surface of the transmission bevel gear 30 is symmetrically fixed with a connecting rod 46 on the left and right sides. A ring block 45 is fixedly provided.

Beneficially, the fan-shaped bevel gear 31 can mesh with the transmission bevel gear 30 after rotating.

Advantageously, four weight blocks 14 are evenly connected to the support base 10, and the weight blocks 14 are used to stabilize the support base 10.

The sequence of mechanical actions of the entire device:

(1) When the external wind is strong, and the wind direction is left or right facing or facing away from the satellite pot 28, the wind blows the windshield 23 to the pressure sensor 35, the moving spring 21 is stretched, and the pressing block 18 As the windshield 23 moves, the pressure sensor 35 is squeezed.

(2) The pressure sensor 35 receives pressure and sends a signal to the power motor 40. The power motor 40 is started. The power motor 40 drives the driving shaft 41 to rotate. The bottom rod 39 and the locking arc 37 rotate with the driving shaft 41. The cylindrical pin 38 follows the bottom rod. 39 rotation, 180 rotation of the cylindrical pin 38 can cause the hexagonal groove wheel 13 to rotate 60 degrees, and the windshield plate 23 and the satellite pot 28 rotate 60 degrees with the hexagonal groove wheel 13, and the satellite pot 28 and the windshield plate 23 are intermittent. Rotate until the satellite pot 28 turns to the side to the wind direction. The moving spring 21 is reset, driving the pressure block 18 and the windshield 23 away from the pressure sensor 35. The pressure sensor 35 stops sending signals, the power motor 40 stops working, and the satellite pot 28 stops. Turn.

(3) When the external wind is too strong to adjust the direction of the satellite pot 28, the moving block 20 moves with the windshield 23 and pushes the rotation lever 26 to rotate, and the rotation lever 26 rotates to push the ring block 45 to rise, and the transmission bevel gear 30 rises with the ring block 45 The movement spring 29 is compressed. At this time, the rotation of the fan-shaped bevel gear 31 cannot mesh with the transmission bevel gear 30, and the angle of the satellite pot 28 cannot be fine-tuned.

(4) When there is no wind, or when the satellite pan 28 is facing sideways to the wind direction, if the satellite pan 28 receives a bad signal, the adjustment motor 33 can be started to drive the power shaft 32 to rotate, and the fan-shaped bevel gear 31 follows the power shaft 32 Rotation, the sector bevel gear 31 can be engaged with the transmission bevel gear 30, which drives the transmission bevel gear 30 to rotate, the compression spring 48 is compressed, the satellite pot 28 rotates with the transmission bevel gear 30, and the sector bevel gear 31 rotates to disengage from the transmission bevel gear 30 At this time, the reset of the pressure spring 48 drives the satellite pot 28 to reset.

(5) The satellite pot 28 rotates repeatedly at a certain angle. When the signal is adjusted, the adjustment motor 33 is turned off.

The above embodiment are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A rotatable windproof satellite pot, comprising a support base, characterized in that a working cavity is provided in the support base, a load-bearing block is provided on the upper side of the support base, and an upper side of the load-bearing block is provided In a satellite pot, an intermittent motion mechanism is provided in the working cavity, and a lower end wall of the intermittent motion mechanism is rotatably provided with a transmission shaft whose upper end penetrates the upper end wall of the working cavity, and the transmission shaft in the working cavity is fixedly provided with Hexagonal sheave, a locking arc matching the hexagonal sheave is provided on the right side of the hexagonal sheave, and a cylindrical pin is provided on the lower side of the locking arc, and the locking arc can block the hexagonal sheave from actively Rotating, through the cooperation of the locking arc and the hexagonal sheave, rotating the cylindrical pin 180 degrees can drive the hexagonal sheave to rotate 60 degrees, and the satellite pot can follow the hexagonal sheave Turn sixty degrees the load-bearing block is provided with a wind detection mechanism. The wind-detection mechanism includes a pressure sensor embedded in the load-bearing block. The pressure sensor is symmetrically provided with pressing blocks on the left and right sides. A wind deflector is provided, and the wind deflector moves toward the pressure sensor under the action of wind. The pressing block moves with the wind deflector. When the pressing block gives the pressure sensor pressure, The pressure sensor can drive the cylindrical pin to rotate; an adjustment mechanism is provided on the upper side of the wind detection mechanism, and the adjustment mechanism is used to repeatedly adjust the satellite pot angle in a small range.

2. The rotatable windproof satellite pot according to claim 1, wherein the intermittent motion mechanism further comprises a power motor fixedly connected to the lower end wall of the working chamber, and the power motor is located on the transmission On the right side of the shaft, a driving shaft is provided on the upper end surface of the power motor for rotation. A bottom rod and the locking arc are fixed on the driving shaft, and the cylindrical pin is fixed on the right side of the upper end surface of the bottom rod.

3. The rotatable windproof satellite pot according to claim 1, wherein the wind detection mechanism further comprises two storage cavities which are symmetrically arranged in the load-bearing block, and the openings of the storage cavities are far away from each other. In the pressure sensor, the upper and lower end walls of the storage cavity are symmetrically provided with a moving slot opening toward the storage cavity, and the end wall of the moving slot away from the pressure sensor is fixed with a moving spring, and the moving spring is close to the one end of the pressure sensor is fixedly provided with a moving block slidingly connected to the moving groove, and a support rod penetrating the storage cavity at one end away from the pressure sensor is fixed between the two moving blocks. The end surface of the support rod near the pressure sensor is fixedly connected, the windshield is fixedly connected with the end surface of the support rod away from the pressure sensor, and the upper end wall of the moving groove on the upper side is provided with a top cavity communicating with external space.

4. The rotatable windproof satellite pot according to claim 1, wherein the adjustment mechanism further comprises an adjustment motor fixedly connected to the right side of the upper end surface of the load-bearing block, and the left end surface of the adjustment motor rotates A power shaft is provided. A fan-shaped bevel gear is fixed at the left end of the power shaft. An extension rod is symmetrically fixed on the upper end surface of the load bearing block. A positioning rod is fixed on the front surface of the extension rod. A spring rod is provided to rotate, and the upper end of the transmission shaft is fixedly connected to the pressure sensor. A top rod fixedly connected to the load-bearing block is fixed on the upper end surface of the pressure sensor, and an opening is provided in the upper end surface of the top rod. The pressure chamber is upward, the lower end wall of the pressure chamber is rotated by a pressure spring, and a connecting shaft having an upper end penetrating the upper end wall of the pressure chamber is provided. The upper end of the connecting shaft is fixedly connected to the satellite pot, and the connecting shaft is in external space. The right end surface is provided with a movement slot opening to the right, a movement spring is fixed on the upper end wall of the movement groove, and a sliding connection with the movement groove is fixed on the lower end of the movement spring. A moving rod, the right end of the moving rod penetrates the right end wall of the moving groove and is fixed with a transmission bevel gear. The lower end face of the transmission bevel gear is symmetrically fixed with a connecting rod. The lower ends of two connecting rods are fixed with a ring shape. Piece.

5. A rotatable windproof satellite pot according to claim 4, characterized in that the fan-shaped bevel gear can be engaged with the transmission bevel gear after rotating.

6. The rotatable windproof satellite pot according to claim 1, wherein four weight blocks are evenly connected to the support base, and the weight blocks are used to stabilize the support base.
